(19) United States
(12) Patent Application Publication
(10) Pub. No.: US 2023/0049850 A1
(43) Pub. Date: Feb. 16, 2023

(54) SERVER DEVICE AND PROGRAM

(71) Applicant: TOSHIBA TEC KABUSHIKI KAISHA, Tokyo (JP)

(72) Inventors: Hidenori SOMEYA, Ichikawa Chiba (JP); Makoto NISHIDA, Yokohama Kanagawa (JP); Kazuki NAKAMURA, Ota Tokyo (JP)

(21) Appl. No.: 17/870,650

(22) Filed: Jul. 21, 2022

(30) Foreign Application Priority Data
Aug. 10, 2021 (JP) 2021-130490

(51) Int. Cl. G06Q 30/02; G06Q 30/06

(52) U.S. Cl. CPC G06Q 30/0281; G06Q 30/0601

(57) ABSTRACT

According to one embodiment, a server includes a storage unit, a communication interface to connect to store servers and customer terminals, and a control unit. The control unit is configured to receive an order from a customer terminal via the communication interface for an item at a store in a plurality of stores at a facility shared by the plurality of stores and output a seat congestion information request to the customer terminal. The seat congestion information request causes the customer terminal to display a request on the customer terminal for an input of congestion information indicating a congestion state of shared seats at the facility. The control unit receives the congestion information from the customer terminal device and tracks the congestion state of the shared seats based on the received congestion information.

### CROSS-REFERENCE TO RELATED APPLICATION

This application is based upon and claims the benefit of priority from Japanese Patent Application No. 2021-130490, filed Aug. 10, 2021, the entire contents of which are incorporated herein by reference.

### FIELD

Embodiments described herein relate generally to a server device and a program.

### BACKGROUND

There is a system that indicates a congestion state of a store (e.g., a restaurant) to a user who is considering using the store (for example, JP-A-2014-71550). The system collects congestion information, such as the number of waiting people, from a plurality of stores and then provides this congestion information in response to a request of a user.

However, a food court with a plurality of stores in a shopping center or the like shares seats among the stores. Furthermore, the food court seats are not generally limited even to just people ordering food from a food court store. That is, even people not purchasing commodities in the stores can use the seats. Accordingly, if a system such as in the related art that acquires the congestion information indicating the number of waiting people in the stores is adopted in a food court setting or the like, the potentially relevant congestion information regarding the current usage of shared seats cannot be provided to the user.

It has been considered to provide, for example, a camera for imaging seats of a food court or a seat sensor for detecting use of the seats to detect a congestion state of the shared seats. However, in such a case, additional equipment is necessary and investment cost increases.

### BRIEF DESCRIPTION OF THE DRAWINGS

FIG. 1 is a diagram illustrating an overview of a congestion information notification system in an embodiment.

FIG. 2 is a diagram illustrating a food court to which a congestion information notification system can be applied.

FIG. 3 is a block diagram illustrating hardware aspects of a portable terminal in an embodiment.

FIG. 4 is a block diagram illustrating functional aspects of a portable terminal in an embodiment.

FIG. 5 is a block diagram illustrating hardware aspects of a server device in an embodiment.

FIG. 6 is a diagram illustrating a data configuration of a member master stored in a memory unit of a server device.

FIG. 7 is a diagram illustrating a data configuration of a store master stored in a memory unit of a server device.

FIG. 8 is a diagram illustrating a data configuration of a menu master stored in a memory unit of a server device.

FIG. 9 is a diagram illustrating a data configuration of a seat congestion information management file stored in a memory unit of a server device.

FIG. 10 is a diagram illustrating a data configuration of a store congestion information management file stored in a memory unit of a server device.

FIG. 11 is a diagram illustrating a data configuration of an order information management file stored in a memory unit of a server device.

FIG. 12 is a block diagram illustrating functional aspects of a server device.

FIG. 13 is a sequence chart illustrating an operation flow of a congestion information notification of a congestion information notification system.

FIGS. 14A, 14B, and 14C are each diagrams illustrating a display screen of a portable terminal at a congestion information notification time in an embodiment.

FIG. 15 is a sequence chart illustrating an operation flow of a seat congestion information update of a congestion information notification system.

FIGS. 16A, 16B, and 16C are each diagrams illustrating a display screen of a portable terminal at a seat congestion information update time in an embodiment.

FIG. 17 is a sequence chart illustrating an operation flow of a store congestion information update of a congestion information notification system.

FIG. 18 is a diagram illustrating a display screen of a portable terminal at a store congestion information update time in an embodiment.

FIG. 19 is a flowchart illustrating congestion information notification processing of a server device according to an embodiment.

FIG. 20 is a sequence chart illustrating a flow of an operation for a seat congestion information update in a modification.

FIG. 21 is a flowchart illustrating seat congestion information update processing of a server device in the modification.

### DETAILED DESCRIPTION

An object of an embodiment is to provide a technological solution to address existing problems in the related art related to provision of congestion information regarding shared seats or the like to a user without requiring installation of additional equipment at the location of the food court or the like.

According to one embodiment, a server device includes a storage unit, a communication interface configured to connect to store servers and customer terminals, and a control unit. The control unit is configured to receive an order from a customer terminal via the communication interface for an item at a store in a plurality of stores at a facility shared by the plurality of stores and output a seat congestion information request to the customer terminal. The seat congestion information request causes the customer terminal to display a request on the customer terminal for an input of congestion information indicating a congestion state of shared seats at the facility. The control unit receives the congestion information from the customer terminal device and tracks the congestion state of the shared seats based on the received congestion information.

A server device and a software program for a server device in one or more example embodiments are explained below with reference to the drawings.

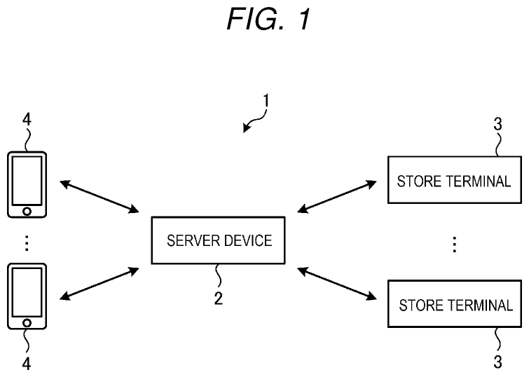

FIG. 1 is a diagram illustrating an overview of a congestion information notification system 1. A congestion information notification system 1 in this example is applied to a food court in a shopping center. The food court is a facility including a plurality of stores with seats shared by customers of the plurality of stores. In other examples, the congestion information notification system 1 can be applied to other scenarios or individual stores without being limited to food courts.

The congestion information notification system 1 includes a server device 2, store terminals 3, and portable terminals 4. The server device 2 and the store terminals 3 are communicably connected to each other via a network such as a LAN (Local Area Network). The server device 2 and the portable terminals 4 are communicably connected to each other via the Internet or a network such as a wireless LAN in the shopping center.

The server device 2 tracks a congestion state of the food court and orders from users. The server device 2 is managed by an operating company of the food court, for example. The store terminals 3 are respectively provided in the plurality of stores (restaurants) set in the food court. The portable terminals 4 are information communication terminals such as smartphones carried by users (customers) who use the food court.

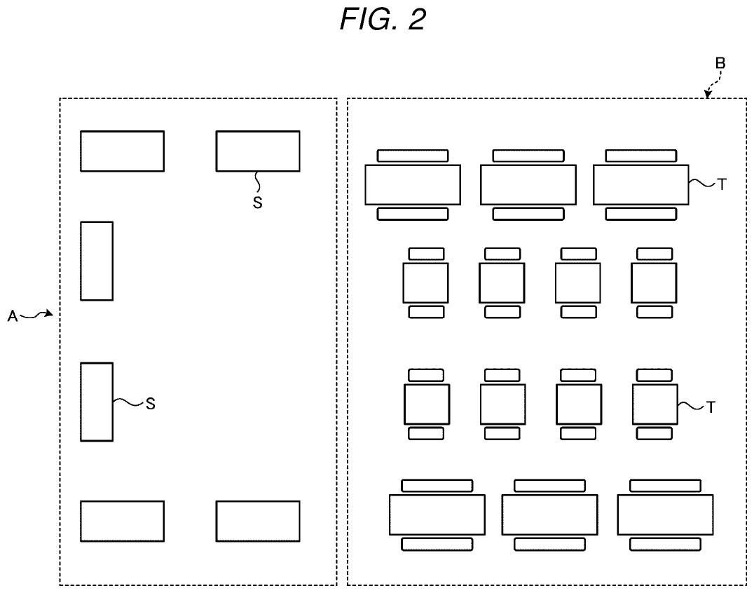

FIG. 2 illustrates a layout of the food court. The food court is an eating and drinking space with shared seats that can used by users. The food court includes a store area A and a seat area B

A plurality of stores S are provided in the store area A. The stores S each include at least one store terminal 3. The seat area B is an area where users eat and drink items purchased from the stores S. However, there is generally no limit on use of the seat area B and even shoppers who do not purchase items from the stores S may also use the seat area B. A plurality of seats T are provided in the seat area B.

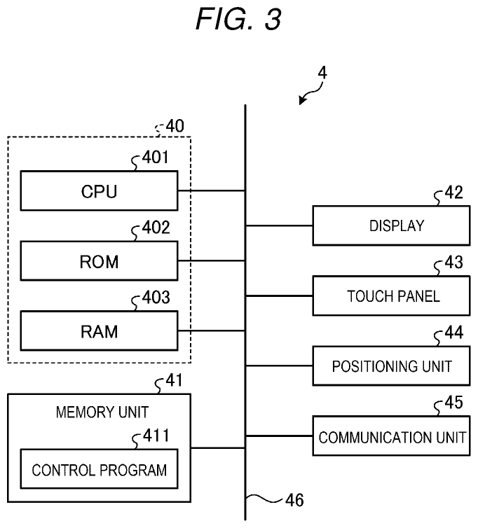

The portable terminal 4 is explained. FIG. 3 is a block diagram illustrating a hardware configuration of a portable terminal 4. The portable terminal 4 includes a control unit 40, a memory unit 41, a display 42, a touch panel 43, a positioning unit 44, and a communication unit 45. The control unit 40, the memory unit 41, the display 42, the touch panel 43, the positioning unit 44, and the communication unit 45 are connected to one another via a bus 46 or the like.

The control unit 40 includes a CPU (Central Processing Unit) 401, a ROM (Read Only Memory) 402, and a RAM (Random Access Memory) 403. The CPU 401, the ROM 402, and the RAM 403 are connected to one another via the bus 46. The CPU 401 controls the overall operations/functioning of the portable terminal 4. The ROM 402 stores various programs such as a program used for driving of the CPU 401 and various data. The RAM 403 is used as a work area of the CPU 401. Various programs and various data stored in the ROM 402 and the memory unit 41 are loaded in the RAM 403. The CPU 401 operates according to a control program stored in the ROM 402 or the memory unit 41 that is loaded in the RAM 403, whereby the control unit 40 executes various kinds of control processing for the portable terminal 4.

The memory 41 can be a storage medium such as an HDD (Hard Disk Drive) or a flash memory and maintains stored content even if a power supply is turned off. The memory unit 41 stores a control program 411.

The control program 411 can be, for example, a Web browser for browsing a website of the food court or a control program for executing various kinds of processing for receiving congestion information of the food court.

The display 42 is, for example, a liquid crystal panel and displays various kinds of information. For example, the display 42 displays congestion information, menu information, and the like received from the server device 2. The display 42 displays, for example, a screen for receiving operations of a user such as an input screen for the user to input seat congestion information indicating a congestion state of the seat T.

The touch panel 43 is provided on the surface of the display 42 and provides information corresponding to a position touched by the user to the control unit 40. The touch panel 43 sends, according to operation of the user, information to the control unit 40 for performing member registration for registering as a food court member, information for logging in to the website of the food court, or seat congestion information indicating a congestion state of the seats T.

The positioning unit 44 measures, calculates, or detects the present location of the portable terminal 4. The positioning unit 44 can be or incorporate a position measuring device that makes use of, for example, a GPS (Global Positioning System) technique or a beacon positioning technique. If the portable terminal 4 is determined to be in area of the food court by the positioning unit 44, the portable terminal 4 outputs information indicating the portable terminal 4 is in the food court along with a member ID to the server device 2.

The communication unit 45 is an interface for communicating with an external device such as the server device 2. The control unit 40 is connected to the external device via the communication unit 45 to be capable of transmitting and receiving information (data) to and from the external device.

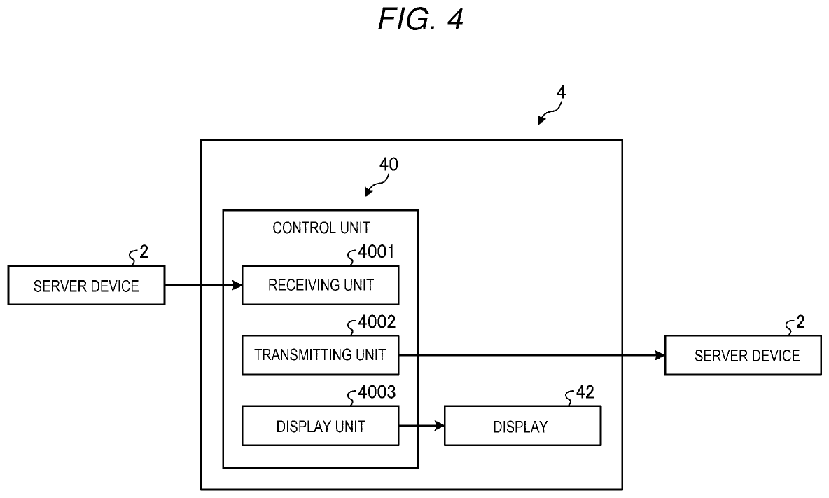

FIG. 4 is a block diagram illustrating certain functional aspects of the portable terminal 4. The CPU 401 operates according to a control program stored in the ROM 402 or the memory 41. By execution of the control program, the control unit 40 functions as a receiving unit 4001, a transmitting unit 4002, and a display unit 4003. In other examples, the corresponding functions may be provided by hardware such as a dedicated circuit. In FIG. 4, two server devices 2 are illustrated primarily for descriptive convenience. However, in other examples, the portable terminal 4 may transmit and receive data to and from just one server device 2 (that is, the two server devices 2 depicted in FIG. 4 may be the same server device 2).

The receiving unit 4001 receives seat congestion information indicating a congestion state of the seats T and store congestion information indicating a congestion state of each of the stores S from the server device 2 in response to a request transmitted by the transmitting unit 4002. In the following explanation, the seat congestion information and the store congestion information are sometimes collectively referred to as “congestion information”. The receiving unit 4001 receives various kinds of information such as menu information of the stores S from the server device 2. The receiving unit 4001 also receives information for measuring the position of the portable terminal 4. The receiving unit 40001, for example, receives a beacon signal from a beacon device provided in the food court.

The transmitting unit 4002 transmits a request for seat congestion information (a first-type request) and a request for requesting the store congestion information (a second-type request) to the server device 2. The transmitting unit 4002 also transmits to the server device 2 the information indicating the presence of the portable terminal 4 in the food court (also referred to as “position information”) and various kinds of information input via the touch panel 43 according to necessity.

The display unit 4003 causes the display 42 to display the seat congestion information and the store congestion information received by the receiving unit 4001. The display unit 4003 may also cause the display 42 to display other various kinds of information in conjunction with the congestion information.

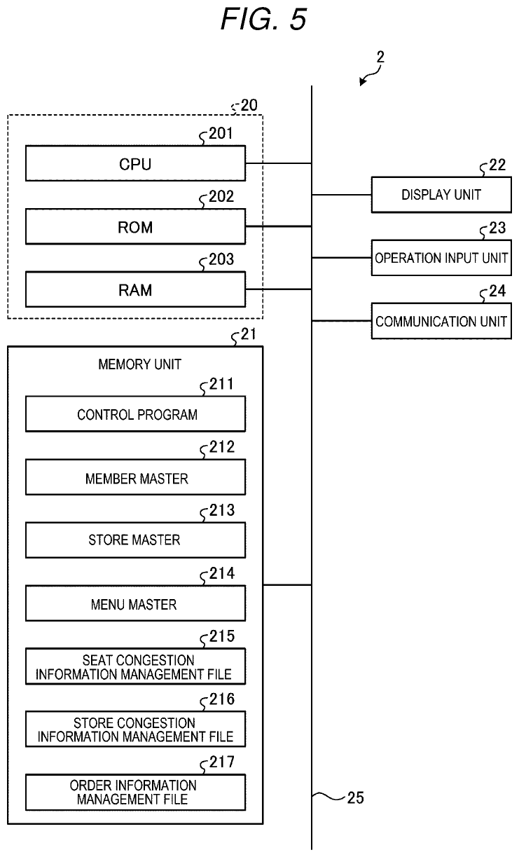

FIG. 5 is a block diagram illustrating a hardware configuration of a server device 2. The server device 2 includes a control unit 20, a memory unit 21, a display unit 22, an operation input unit 23, and a communication unit 24. The control unit 20, the memory unit 21, the display unit 22, the operation input unit 23, and the communication unit 24 are connected to one another via a bus 25 or the like.

The control unit 20 includes a CPU 201, a ROM 202, and a RAM 203. The CPU 201, the ROM 202, and the RAM 203 are connected to one another via the bus 25. The CPU 201 controls the overall operations/functions of the server device 2. The ROM 202 stores various programs such as a program used for driving of the CPU 201 and various data. The RAM 203 is used as a work area of the CPU 201. Various programs and various data stored in the ROM 202 and the memory unit 21 are loaded in the RAM 203. The CPU 201 operates according to a control program stored in the ROM 202 or the memory 21 and loaded in the RAM 203. By execution of the control program, the control unit 20 executes various kinds of control processing for the server device 2.

The memory unit 21 is a storage medium such as an HDD or a flash memory and maintains stored content even if a power supply is turned off. The memory unit 21 stores a control program 211, a member master 212, a store master 213, a menu master 214, a seat congestion information management file 215, a store congestion information management file 216, and an order information management file 217.

The control program 211 is, for example, a control program for managing seat congestion information and store congestion information and a control program for outputting the seat congestion information and the store congestion information to the portable terminal 4.

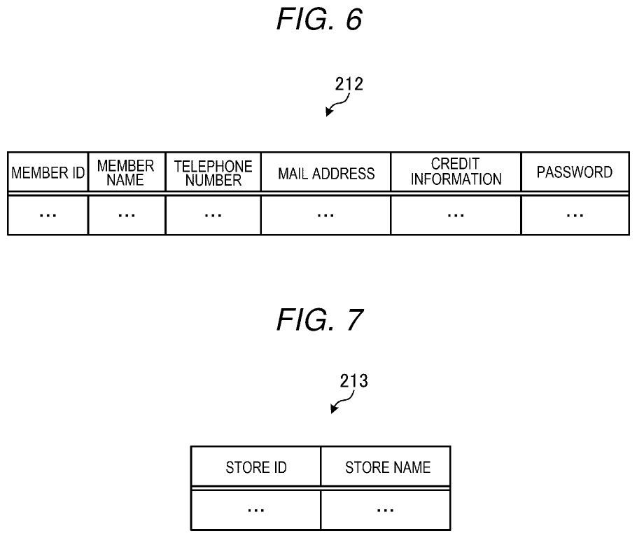

The member master 212 is a master file for managing information concerning members authorized or otherwise eligible to use a congestion information provision service by the server device 2. FIG. 6 is a diagram illustrating a data configuration of the member master 212. In the member master 212, various kinds of information indicating a member ID, a member name, a telephone number, a mail address, credit card information (“credit information”), and a password can be associated. When the user performs a member registration, the server device 2 acquires the information to be registered in the member master 212.

Registration of user credit card information is optional. A user who does not pre-register credit card information may provide credit card information to the portable terminal 4 every time the user executes credit card settlement using the portable terminal 4 or the like. The stored password information is a password provided by the user at member registration or the like. The password is supplied when the member logs in to the food court website.

The store master 213 is a master file for managing information about all the stores S in the food court. FIG. 7 is a diagram illustrating a data configuration of the store master 213. In the store master 213, a store ID (unique to each store S) and a store name are associated with each other. In the store master 213, a store ID and a store name are in association with each other for each of the stores S in the food court. The store master 213 can be updated if a new store S is opened in the food court or a store S in the food court is closed.

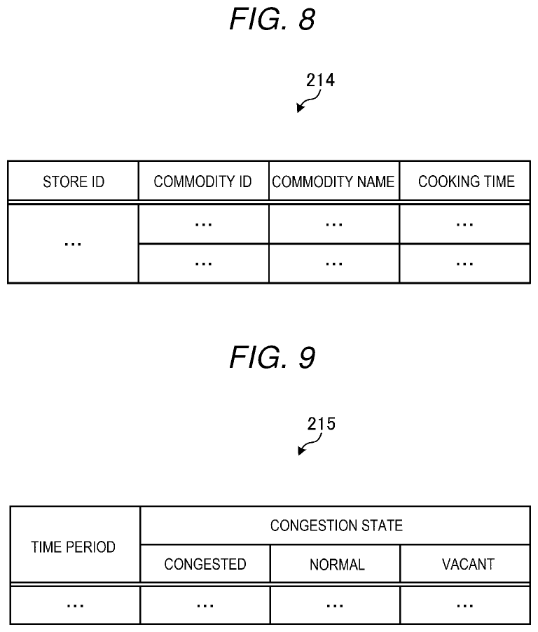

The menu master 214 is a master file for managing menus of all the different stores S in the food court. FIG. 8 is a diagram illustrating a data configuration of the menu master 214. In the menu master 214, respective kinds of information indicating a store ID, a commodity ID, a commodity name, and a cooking time are associated with one another. The server device 2 acquires the information registered in items of the menu master 214 from the store terminals 3 of the stores S.

In this context, the cooking time value is information indicating estimated time required for the store S to cook (or otherwise prepare) the menu item corresponding to the ordered commodity ID of the commodity. In the menu master 214, a commodity image (e.g., a picture of the menu item) and any other additional information specific to the commodity ID, or the like can be registered according to necessity.

The seat congestion information management file 215 is a file for tracking a congestion state of the seats T in the food court. In this context, the “congestion state of the seats T” refers to an occupancy level or other measure of seat availability. FIG. 9 is a diagram illustrating a data configuration of the seat congestion information management file 215. In the seat congestion information management file 215, a time period and information indicating or reflecting a congestion state are associated with each other. The information concerning the congestion state is divided into items of “congested”, “normal”, and “vacant”. The seat congestion information management file 215 can be updated at any time based on seat congestion information transmitted from the portable terminals 4 of the users. The information concerning the congestion state is not limited to the categories of “congested”, “normal”, and “vacant”. For example, the number of possible categories may be reduced to two categories of “congested” and “vacant” or may be increased. The number of categories can be optionally set.

In the time period column of the seat congestion information management file 215, information indicating a particular time period is registered. For example, entries for “12:01 to 12:15” and “12:16 to 12:30” can be registered as information indicating time periods of every 15 minutes. The operating company of the food court can arbitrarily select the time period increment value.

In the present example, the information indicating the congestion state is provided by feedback from registered members. Thus, in the “congested” column, information indicating the number of members feeling that the seats T are presently congested during the relevant time period is registered. Likewise, in the “normal” column, information indicating the number of members feeling the seats T are normally congested (that is, neither particularly congested nor particularly vacant) is registered. In the “vacant” column, information indicating the number of members feeling that the seats T are vacant (that is, widely available) is registered.

The items of the member-perceived congested, normal, and vacant states are updated every time the server device 2 receives seat congestion information from a portable terminal 4. The seat congestion information management file 215 can be considered representing a congestion state of the seats T in every time period. In some examples, the seat congestion information management file 215 may store only information indicating a congestion state at the present time (present time period) rather than storing information about any previous time periods.

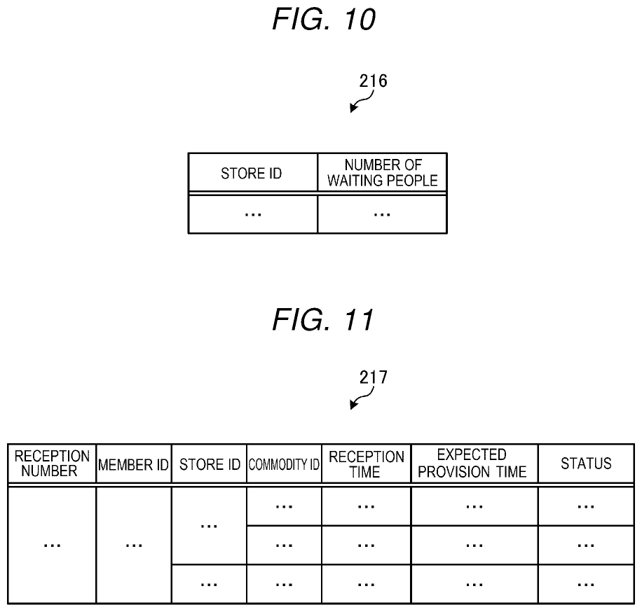

The store congestion information management file 216 is a file for tracking a congestion state of the individual stores S in the food court. FIG. 10 is a diagram illustrating a data configuration of the store congestion information management file 216. In the store congestion information management file 216, a store ID and the number of waiting people at the corresponding store are associated with each other. The store congestion information management file 216 can be updated whenever new information is acquired by the server device 2 from the store terminals 3 of the various stores S.

The store ID is, for example, a code number or the like for identifying a particular store S. The value for the number of waiting people reflects the number of customers currently waiting for provision of items at the store S. In some examples, instead of, or in addition to, tracking the number of people waiting at a store S, an expected or estimated service waiting time may be tracked.

The order information management file 217 is a file for tracking, on a per store basis, information concerning the orders placed at the store S. FIG. 11 is a diagram illustrating a data configuration of the order information management file 217. In the order information management file 217, a reception number, a member ID, a store ID, a commodity ID, a reception time, an expected provision time, and a status are associated with one another.

The reception number is for identifying order information received by the server device 2 from a portable terminal 4. If the server device 2 receives the order information from the portable terminal 4 and settlement relating to the order information is completed, the server device 2 dispenses a reception number and registers the reception number in the item of the reception number column. A new reception number is dispensed every time the order information is received and may sometimes include orders placed at a plurality of stores S.

The member ID is for identifying the member who has placed an order. The store ID is for identifying the store S providing an ordered item included in the order information (also referred to as “ordered commodity” as well). The commodity ID is for identifying the particular items that have been ordered.

The reception time is information indicating time when the server device 2 received the order from the portable terminal 4. The expected provision time is information indicating the expected time when the ordered commodity will be provided to the customer (member). The server device 2 in this example calculates an expected provision time based on a cooking time for the ordered commodity and information indicating the number of already waiting people at the store S providing the ordered commodity. The information regarding item cooking time and the number of waiting people may be provided by the store terminal 3 of the store S providing the ordered commodity.

The status of the received order is registered in the “STATUS” field. For example, that a status may be “cooking” (in progress) or “commodity provided” (completed). The status is updated based on, for example, information acquired by the server device 2 from the store terminals 3. The information indicating the reception time, the expected provision time, and the status can be registered for each of the ordered commodities

If the stores S are enabled to individually receive orders, the server device 2 can acquire information concerning orders from the store terminals 3 of the stores S and update the order information management file 217 as appropriate.

Referring back to FIG. 5, a hardware configuration of the server device 2 is explained.

The display unit 22 can be a liquid crystal panel or the like and displays various kinds of information. For example, the display unit 22 displays an input screen permitting the inputting of various kinds of information.

The operation input unit 23 can be a keyboard, a touch panel provided on the surface of the display unit 22, or the like. The operation input unit 23 sends, based on operations of an operator/administrator, various kinds of information such as information for setting a time period of the seat congestion information management file 215 to the control unit 20.

The communication unit 24 is an interface for communicating with external devices such as the store terminals 3 and the portable terminals 4. The control unit 20 is connected to the external devices via the communication unit 24 to be capable of transmitting and receiving information (data) to and from the external devices.

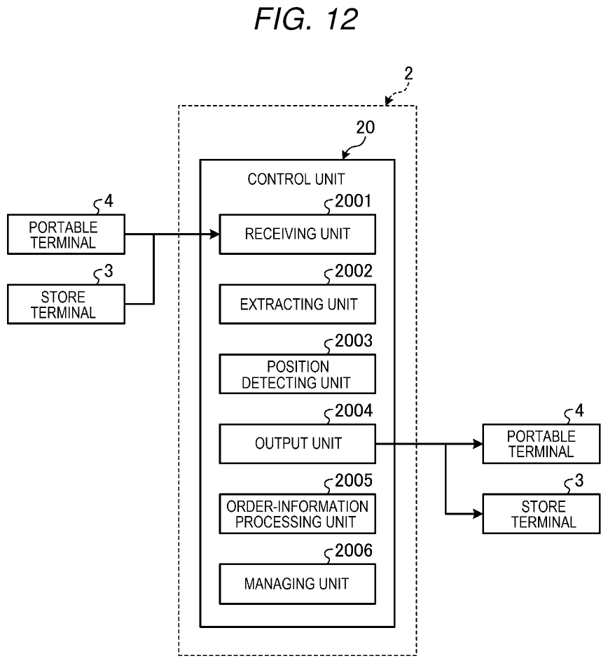

FIG. 12 is a block diagram illustrating functional aspects of the server device 2. The CPU 201 operates as a control unit 20 according to a control program stored in the ROM 202 or the memory unit 21. The control unit 20 functions as a receiving unit 2001, an extracting unit 2002, a position detecting unit 2003, an output unit 2004, an order-information processing unit 2005, and a managing unit 2006. These functions may be provided or implemented by hardware such as a dedicated circuit in some examples rather than by programmed functions of CPU 201 or the like. In FIG. 12, two server devices 2 are illustrated. However, one server device 2 may be used in some examples, and the depiction in FIG. 12 is primarily for purposes of explanation of interactions between systems rather than arrangements of the various components.

The receiving unit 2001 functions as an order-information receiving unit that receives order information from a terminal device operated by a customer. Specifically, the receiving unit 2001 receives order information from the portable terminal 4 carried by a user. The order information is information including a member ID, a store ID, and a commodity ID indicating the item ordered by the user from a store S.

The receiving unit 2001 functions as a congestion-information receiving unit that receives congestion information input via a terminal device (e.g., a portable terminal 4) in response to a request output by the output unit 2004. Specifically, in this example, the receiving unit 2001 receives, from a portable terminal 4, seat congestion information input to the portable terminal 4 by the user in response to a seat congestion information input request output to the portable terminal 4 by the output unit 2004. The seat congestion information received by the receiving unit 2001 is, for example, information indicating any one of “vacant”, “normal”, and “congested” congestion state categories.

The receiving unit 2001 also functions as a completion-information receiving unit that receives preparation completion information indicating that an ordered item is ready for pickup at a store S. Specifically, the receiving unit 2001 receives, from a store terminal 3, a cooking completion notification indicating that cooking of the ordered commodity is completed. The cooking completion notification is an example of the preparation completion information.

The receiving unit 2001 may also receive other various kinds of information from the store terminals 3 and the portable terminals 4. For example, the receiving unit 2001 may receive store congestion information from the store terminals 3. The store congestion information is, for example, information indicating the number of waiting people (the number of customers waiting for provision of commodities), a waiting time (an expected time until an ordered commodity can be ready), the number of received orders, and the number of unfilled orders for which commodities are not yet ready. In some examples, the store congestion information may be based on information generated by combining these kinds of information. The receiving unit 2001 also receives, from the portable terminals 4, a first-type request, which is a request for seat congestion information, and a second-type request, which is a request for store congestion information.

The extracting unit 2002 extracts seat congestion information from the seat congestion information management file 215. For example, if the receiving unit 2001 receives the first-type request, the extracting unit 2002 refers to the seat congestion information management file 215. The extracting unit 2002 extracts, as the seat congestion information, the congestion state for which the number of registered people is the largest in the time period matching the time period in which the first-type request was received or the time period immediately before the present time period. The value of the congestion state to be extracted is any one of “congested”, “normal”, and “vacant” set as the items in the seat congestion information management file 215.

The extracting unit 2002 extracts store congestion information from the store congestion information management file 216. For example, if the receiving unit 2001 receives the second-type request, the extracting unit 2002 refers to the store congestion information management file 216 and extracts information indicating the number of waiting people in each of the stores S. If a store ID designating a particular store S is included in the second-type request, the extracting unit 2002 extracts information indicating the number of waiting people at the store S corresponding to the store ID from the store congestion information management file 216 and also extracts commodity IDs and the like corresponding to the store ID from the menu master 214.

The position detecting unit 2003 detects whether a terminal device (e.g., a portable terminal 4) that sent order information is located within the area where the seats T are arranged. Specifically, the position detecting unit 2003 detects, based on position information and a member ID received by the receiving unit 2001, that the portable terminal 4 that sent the order information is located in the food court seat area B.

After processing is executed by the order-information processing unit 2005, the output unit 2004 outputs a request for seat congestion information regarding the seats presently available to customers. For example, the output unit 2004 outputs a seat congestion information input request to the portable terminal 4 if settlement for the ordered items was successfully performed.

The output unit 2004 outputs, upon a request from the portable terminal 4, seat congestion information that is tracked in the seat congestion information management file 215 and/or store congestion information that is tracked in the store congestion information management file 216.

The output unit 2004 may also output other information to the portable terminal 4. For example, the output unit 2004 outputs an order completion notification to the portable terminal 4 indicating that an order is complete together with information indicating a reception number for identifying the order information and an expected provision time for the ordered item(s). The output unit 2004 also outputs to the portable terminal 4 a cooking completion notification indicating that the cooking (preparation) of the ordered item(s) is completed together with information indicating the reception number and the commodity name.

The output unit 2004 also outputs various kinds of information to the store terminal 3. For example, the output unit 2004 outputs a commodity ID and the like included in order information received from the portable terminal 4 to the store terminal 3 of the store S that sells the item corresponding to the commodity ID.

The order-information processing unit 2005 executes settlement related processing concerning order information received by the receiving unit 2001 and determines whether the settlement relating to the order information has been successfully completed. The order-information processing unit 2005 may also execute other processing for deciding whether received order information constitutes a valid order. However, the processing is not limited to this. For example, the output unit 2004 may output, to the portable terminal 4, a confirmation request regarding the order information previously received by the receiving unit 2001. The receiving unit 2001 receiving, from the portable terminal 4, an order confirmation may be used to determine whether an order is valid. In some examples, the output unit 2004 may output a seat congestion information request only after the receiving unit 2001 has received an order confirmation. The settlement related processing in this context is processing executed by the server device 2 for receiving payment for the received order. For example, the server device 2 may communicate with a settlement server managed by a settlement agent (e.g., a credit card service or the like).

The order-information processing unit 2005 updates the order information management file 217 based on the order information received by the receiving unit 2001. More specifically, the order-information processing unit 2005 dispenses a reception number for the order information received by the receiving unit 2001 and registers the reception number in the order information management file 217. The order-information processing unit 2005 registers, in the order information management file 217, a member ID for identifying a user, a store ID for identifying a store S, a commodity ID for identifying the ordered item, and a reception time indicating when the order information was received. The order-information processing unit 2005 extracts a cooking time for the ordered item by reference to the menu master 214 and registers an expected provision time that can be calculated from the cooking time, the reception time, and the like. In addition, the order-information processing unit 2005 updates a status of the order based on information received from the store terminal 3.

The managing unit 2006 tracks a congestion state of seats based on congestion information received by the receiving unit 2001. For example, the managing unit 2006 updates the seat congestion information management file 215 based on seat congestion information received by the receiving unit 2001. The managing unit 2006 also updates the store congestion information management file 216 based on store congestion information received by the receiving unit 2001.

The managing unit 2006 captures the congestion information and tracks a congestion state of the seats T assuming the order is confirmed/completed. In some examples, the managing unit 2006 captures seat congestion information received by the receiving unit 2001 before the settlement is completed but only after the settlement relating to order information is completed.

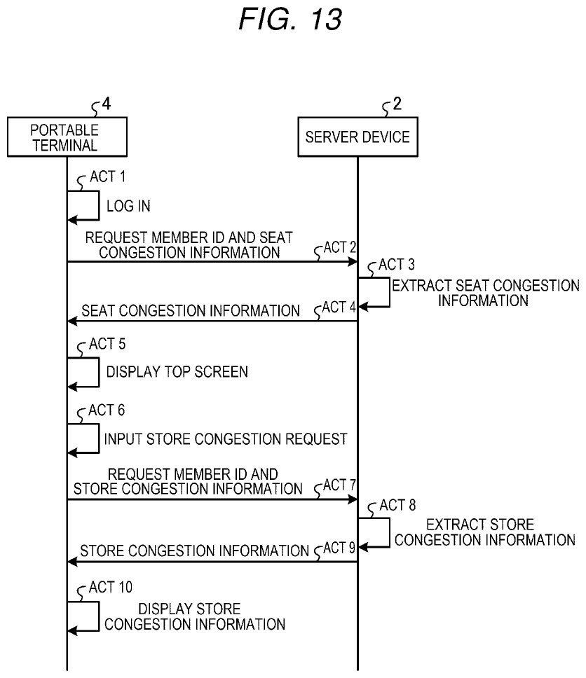

The operation of the congestion information notification system 1 is explained. First, an operation when the server device 2 provides congestion information to the portable terminal 4 of a user is explained. FIG. 13 is a flowchart illustrating a flow of an operation at a congestion information notification time of the congestion information notification system 1.

The user operates the portable terminal 4 and logs in to the website of the food court. For example, the portable terminal 4 scans a two-dimensional code displayed at the shopping center to thereby execute processing for logging in (Act 1). If the processing for logging in is executed, the portable terminal 4 outputs a member ID of the member carrying the portable terminal 4 and a request (a first-type request) for seat congestion information to the server device 2 (Act 2).

After receiving the first-type request, the server device 2 extracts seat congestion information by reference to the seat congestion information management file 215 (Act 3). The seat congestion information to be extracted is one of “congested”, “normal”, or “vacant” for which the number of registered people is the largest in the time period when the first-type request was received. The server device 2 outputs the extracted seat congestion information to the portable terminal 4 (Act 4).

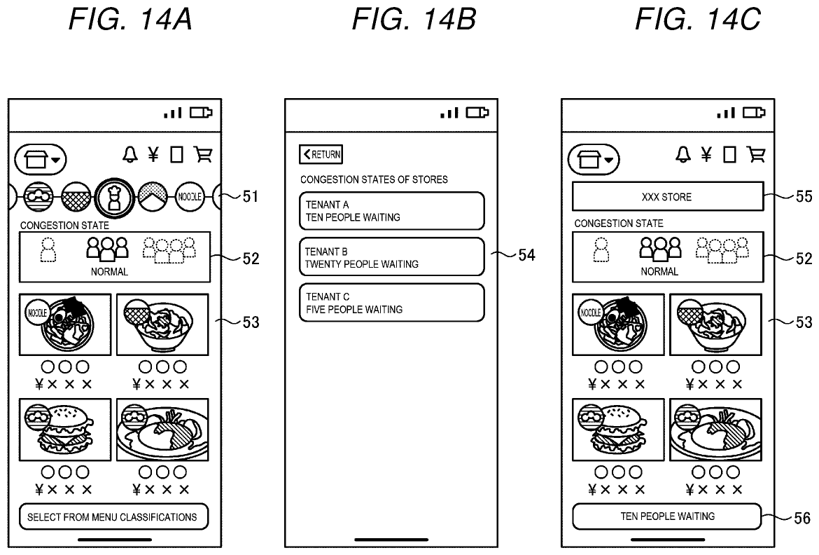

The portable terminal 4 displays a screen (a top screen) including an indication of the seat congestion information acquired from the server device 2 (Act 5). FIG. 14A is a diagram illustrating the top screen displayed on the portable terminal 4. A store selection region 51, a seat congestion information region 52, and a menu region 53 are formed on the top screen.

In the store selection region 51, icons of the stores S open in the food court are displayed. The icons also function as selection buttons for selecting the stores S. The seat congestion information acquired from the server device 2 is displayed in the seat congestion information region 52. In the seat congestion information region 52, three display regions showing “vacant”, “normal”, and “congested” are formed in order from the left in the figure. A display region corresponding to the congestion information acquired from the server device 2 is bright and the other two regions are grayed out. In FIG. 14A, since the seat congestion information acquired from the server device 2 indicates “normal”, the display region showing “normal” is bright and the other two display regions are grayed out. In the menu region 53, for example, menu items recommended by the stores S are displayed. The recommended menu items displayed on the top screen can be optionally set.

Referring back to FIG. 13, if the request for store congestion information (second-type request) is input to the portable terminal 4 (Act 6), the portable terminal 4 outputs the member ID and the second-type request to the server device 2 (Act 7). The user can request congestion information of all the stores S or request congestion information of a specific store S. In FIG. 14A, the user can request the congestion information of all the stores S by touching the seat congestion information region 52 and can request the congestion information of a specific store S by touching the icon of any one of the stores S in the store selection region 51.

If receiving the second-type request, the server device 2 extracts store congestion information by reference to the store congestion information management file 216 (Act 8). The store congestion information to be extracted is, for example, information indicating the number of waiting people. If the second-type request is a request for the congestion information of all the stores S, the server device 2 extracts the store congestion information of all the stores S. If the received second-type request is a request for the congestion information of a specific store S, the server device 2 extracts the store congestion information of the specific store S and also extracts menu information of the specific store S from the menu master 214.

The server device 2 outputs the extracted store congestion information to the portable terminal 4 (Act 9). If the received second-type request is the request for the congestion information of a specific store S, the server device 2 outputs the extracted menu information as well to the portable terminal 4.

The portable terminal 4 displays the store congestion information acquired from the server device 2 (Act 10). FIG. 14B is a display screen in the case in which the portable terminal 4 acquires the congestion information of all the stores S. A congestion information region by store 54 is formed on the display screen. In the congestion information region by store 54, store congestion information associating a store name and the number of waiting people is displayed for the store S in which there are waiting people at a point in time when the second-type request was received.

FIG. 14C is a display screen in the case in which the portable terminal 4 acquired the congestion information of the specific store S. On the display screen, a store name region 55, the seat congestion information region 52, the menu region 53, and a store congestion information region 56 are formed.

In the store name region 55, a name of the store S specified by the second-type request is displayed. In the seat congestion information region 52, the same information as the information displayed in the seat congestion information region 52 on the top screen is displayed. In the menu region 53, a menu of the store S displayed in the store name region 55 is displayed. The portable terminal 4 can display all menu items of the store S displayed in the store name region 55 by scrolling the menu region 53.

According to the operation illustrated in FIG. 13, the congestion information notification system 1 can provide a congestion state of the seats T and a congestion state of the store S in the food court to the user. In this example, the server device 2 receives the first-type request and the second-type request at different times. However, in other examples, the server device 2 may receive the first-type request and the second-type request as one request (consolidated request). In such cases, the server device 2 may output the seat congestion information and the store congestion information at the same time.

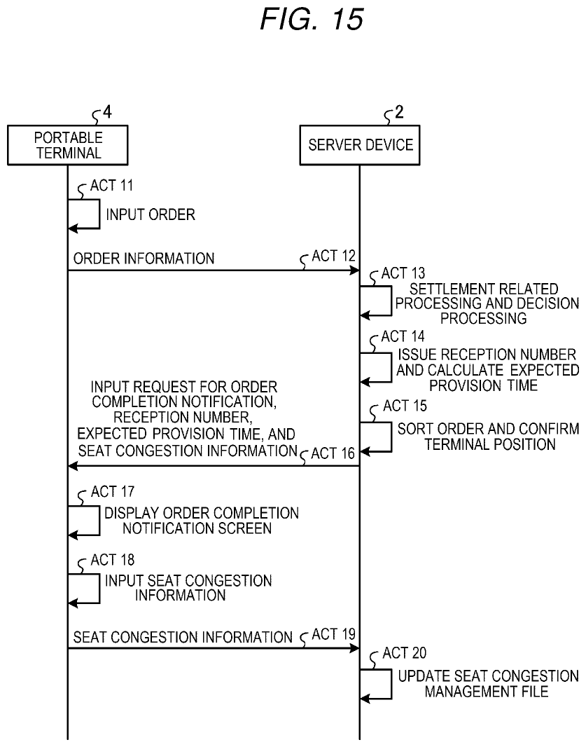

An operation when the server device 2 collects seat congestion information from the portable terminal 4 of the user is explained. FIG. 15 is a sequence chart illustrating a flow of an operation at a seat congestion information update time.

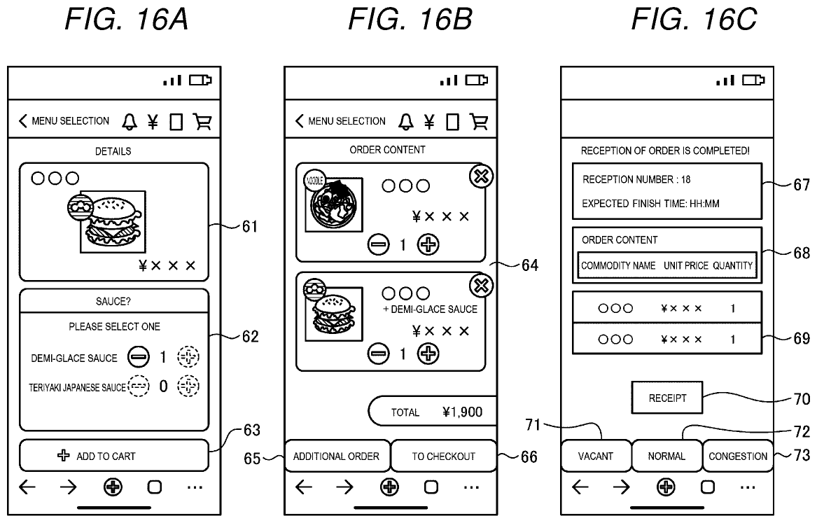

The user can operate the portable terminal 4 and order a commodity irrespective of being inside or outside of the food court. The input relating to the order is performed on the portable terminal 4 by the user (Act 11). FIG. 16A is a diagram illustrating an order input screen. The order input screen is displayed by, for example, the user touching a commodity item displayed in the menu region 53 in FIG. 14C. A commodity information region 61, an additional information region 62, and an order input region 63 are formed on the order input screen.

In the commodity information region 61, information concerning a commodity designated by the user is displayed. The information concerning the commodity to be displayed is, for example, a commodity name, a commodity image, and a price. The additional information region 62 functions as an input screen region to which additional information related to the commodity item can be input. The additional information to be input is, for example, information concerning such things as a type of sauce to be provide with the item and/or a size-selection such as large serving or normal serving. The additional information is set in advance for each of available commodities. The order input region 63 functions as an input screen region for ordering the commodity item displayed in the commodity information region 61.

After the user touches the order input region 63 and inputs, as the ordered commodity, the commodity item displayed in the commodity information region 61, the portable terminal 4 displays a confirmation screen illustrated in FIG. 16B. An ordered commodity region 64, an additional order button 65, and a checkout button 66 are formed on the confirmation screen.

In the ordered commodity region 64, commodity information, a total amount, and the like of the ordered item(s) selected by the user are displayed. The additional order button 65 is operated if order information is to be further input in addition to the commodity item presently displayed in the ordered commodity region 64. If the additional order button 65 is operated, the portable terminal 4 displays, for example, the top screen or a menu screen of the store S that sells the ordered commodity input immediately before the additional order button 65 was operated. The checkout button 66 is a button for deciding an order entry process is complete and requesting settlement.

Referring back to FIG. 15, after the input of the order information is completed, the portable terminal 4 outputs the order information to the server device 2 (Act 12). The order information output from the portable terminal 4 includes a member ID, a commodity ID for identifying an ordered commodity, and a store ID for identifying the store S that provides the ordered commodity.

The server device 2 executes the settlement related processing and other processing based on the order information acquired from the portable terminal 4 (Act 13). For example, the server device 2 reads credit card information corresponding to the acquired member ID from the member master 212, communicates with a settlement server managed by a settlement agent, and executes the settlement related processing for performing settlement relating to the ordered items. If the user did not pre-register credit card information in the member master 212, the server device 2 outputs a request for credit card information to the portable terminal 4 as a part of the settlement related processing. The server device 2 then determines whether the settlement processing relating to the order information has been successfully completed.

The server device 2 dispenses a reception number for the received order information and calculates an expected provision time for the ordered item(s) (Act 14). Subsequently, the server device 2 performs order sorting processing and checks whether the portable terminal 4 is located in the food court (Act 15). The order sorting processing is processing for sending orders for the individual ordered items indicated in the order information to each of the relevant stores S. The server device 2 outputs information relating to the sorted items to the store terminals 3 of the corresponding stores S. The confirmation of whether the portable terminal 4 is located in the food court is performed by determining whether information indicating presence in the food court was received from the portable terminal 4.

After finishing the settlement related processing and the like, and assuming the settlement was successful and the portable terminal 4 is located in the food court, the server device 2 outputs to the portable terminal 4 an order completion notification indicating that the reception of the order is completed, along with the dispensed reception number, the calculated expected provision time(s), and a seat congestion information input request (Act 16). It some examples, it might not be necessary to confirm that the portable terminal 4 is located in the food court before sending the order completion notification and other information.

The portable terminal 4 displays an order completion notification screen based on the information sent from the server device 2 (Act 17). FIG. 16C is a diagram illustrating an order completion notification screen. A message region 67, a reception information region 68, an order information region 69, a receipt button 70, a vacant button 71, a normal button 72, a congestion button 73, and the like are formed on the order completion notification screen.

In the message region 67, a message indicating that the reception of the order is completed is displayed. In the reception information region 68, the reception number issued by the server device 2 and the expected provision time(s) calculated by the server device 2 are displayed. The order content is displayed in the order information region 69. For example, in the order information region 69, a commodity name, a price, and the number of ordered items are displayed in association with one another.

The receipt button 70 is a button for requesting an electronic receipt. If the receipt button 70 is operated, a receipt issue request is output to the server device 2. The server device 2 acquiring the issue request outputs a receipt issue instruction to the store terminals 3 of the stores S that provide the ordered items. The store terminals 3 acquiring the receipt issue instruction transmits an electronic receipt to the portable terminal 4 through the server device 2 or directly.

The vacant button 71, the normal button 72, and the congestion button 73 are buttons for inputting seat congestion information and are displayed based on the seat congestion information input request received from the server device 2. The user selects one of the vacant button 71, the normal button 72, and the congestion button 73 based on the user-perceived congestion state of the seats T in the food court. The server device 2 collects the seat congestion information that is input by the user. The portable terminal 4 may display a message for urging an input of congestion information on the order completion notification screen or may restrict return to a top page or the like if seat congestion information is not first input. Consequently, the server device 2 can collect a lot of seat congestion information from users.

Referring back to FIG. 15, after seat congestion information is input (Act 18), the portable terminal 4 outputs the input seat congestion information to the server device 2 (Act 19). The server device 2 updates the seat congestion information management file 215 based on the seat congestion information sent from the portable terminal 4 (Act 20). For example, in the seat congestion information management file 215, the server device 2 adds one to the number of people indicating the corresponding congestion state based on the seat congestion information sent from the portable terminal 4. The server device 2 may output information for imparting a privilege such as point impartment to the portable terminal 4 that transmits the seat congestion information. Consequently, it is possible to urge the user to input the seat congestion information.

According to the operation illustrated in FIG. 15 explained above, the server device 2 can collect the seat congestion information from the portable terminal 4 of the user who orders the commodity and track the congestion state of the seats T in the food court.

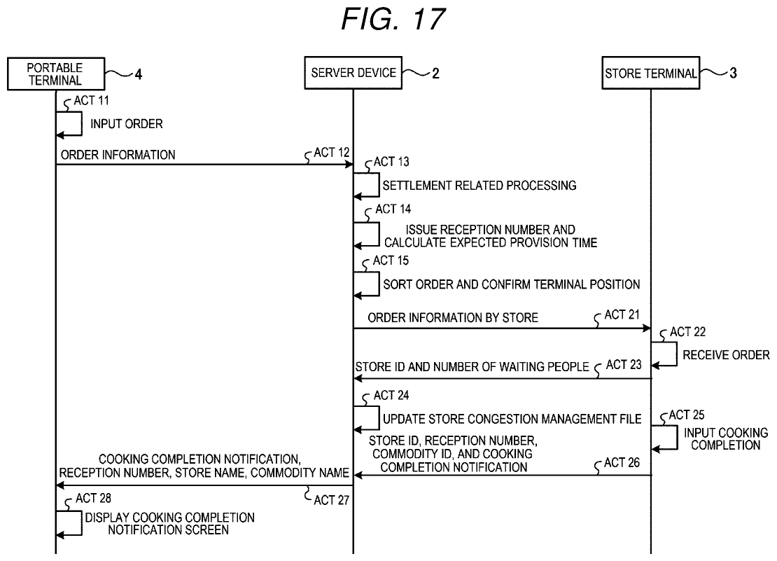

Subsequently, an operation at the time when the server device 2 collects store congestion information from the store terminal 3 is explained. FIG. 17 is a sequence chart illustrating a flow of an operation at a store congestion information update time. In FIG. 17, since processing in Act 11 to Act 15 is the same as the processing illustrated in FIG. 15, redundant explanation of the processing is omitted.

After executing the order sorting processing and the position confirmation processing for the portable terminal 4 in Act 15, the server device 2 outputs order information by store to the store terminal 3 in the store S that sells an ordered commodity (Act 21). The order information by store output from the server device 2 is information including a member ID of a user who makes an order, a reception number issued to order information, and a commodity ID indicating the ordered commodity.

The store terminal 3 executes order reception processing on the order information by store acquired from the server device 2 (Act 22). The order reception processing is, for example, outputting a print instruction for the ordered commodity indicated by the order information by store to a kitchen printer (not illustrated) included in the store S. After executing the order reception processing, the store terminal 3 outputs a store ID of the store S where the store terminal 3 is provided and information indicating the number of waiting people, that is, store congestion information to the server device 2 (Act 23). The information indicating the number of waiting people output by the store terminal 3 may be managed by the store terminal 3 and be automatically output or may be output by manual input by a store clerk of the store S.

The server device 2 updates the store congestion information management file 216 based on the store congestion information acquired from the store terminal 3. Specifically, in the store congestion information management file 216, the server device 2 rewrites, based on the information indicating the number of waiting people acquired from the store terminal 3, the item of the number of waiting people corresponding to the store ID acquired from the store terminal 3 (Act 24).

Thereafter, after cooking of the ordered commodity is completed in the store S, cooking completion is input to the store terminal 3 (Act 25). When the cooking completion is input, the store terminal 3 outputs the store ID indicating the store S where the store terminal 3 is provided, a reception number, a commodity ID of the ordered commodity, and a cooking completion notification indicating that the cooking is completed to the server device 2 (Act 26).

The server device 2 transmits, by electronic mail or the like, to the portable terminal 4, together with the cooking completion notification, information indicating the reception number, a commodity name of the ordered commodity, and a store name of the store S that provides the ordered commodity (Act 27). The server device 2 reads out, from the member master 212, a mail address of the user and transmits the information indicating the cooking completion notification, the reception number, the commodity name, and the store name to the portable terminal 4. The server device 2 may output the information indicating the cooking completion notification, the reception number, the commodity name, and the store name after cooking of all commodities ordered by the user is completed or may output the information every time cooking of an individual commodity ordered by the user is completed.

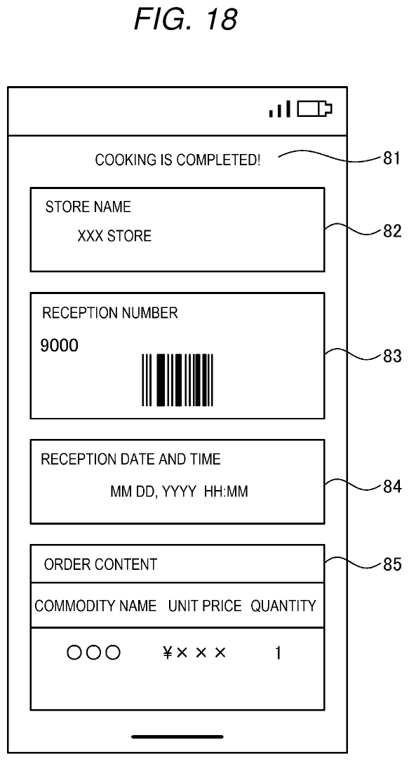

The portable terminal 4 displays a cooking completion notification screen based on the information acquired from the server device 2 (Act 28). FIG. 18 is a diagram illustrating the cooking completion notification screen. A message region 81, a store name region 82, a reception number region 83, a reception date and time region 84, an order content region 85 and the like are formed on the cooking completion notification screen.

In the message region 81, a message indicating that cooking in the store S is completed for an ordered commodity is displayed. In the store name region 82, a name of the store S that provides the commodity for which the cooking is completed is displayed. In the reception number region 83, a reception number issued to order information including the ordered commodity for which the cooking is completed is displayed. In the reception number region 83, a barcode indicating that the user received the ordered commodity is also displayed. The store S can change a status of the ordered commodity managed by the store terminal 3 to “provided” by reading the barcode if the cooked commodity is provided to the user.

In the reception date and time region 84, an order reception date and time of the commodity for which the cooking is completed is displayed. In the order content region 85, a commodity name, a price, and the number of articles of the ordered commodity for which the cooking is completed are displayed in association with one another. The user who received the cooking completion notification can go to the store S displayed in the store name region 82 to receive the commodity.

The server device 2 may transmit an input request for seat congestion information to the portable terminal 4 together with the cooking completion notification. In other words, if receiving the cooking completion notification from the store terminal 3, the server device 2 may output the cooking completion notification and a seat congestion information input request to the portable terminal 4. In this case, the portable terminal 4 can display, on the cooking completion notification screen illustrated in FIG. 18, the vacant button 71, the normal button 72, and the congestion button 73 for inputting seat congestion information displayed on the order completion notification screen illustrated in FIG. 16C.

Consequently, it can be expected that more accurate seat congestion information will be input. This is because, after the cooking completion notification screen is displayed, the user goes to a store S to receive the ordered commodity, thus the user can be considered to be located in the food court after the cooking completion notification screen is displayed.

According to the operation illustrated in FIG. 17 explained above, the server device 2 can collect the store congestion information from the store terminal 3 and track a congestion state of the stores S in the food court.

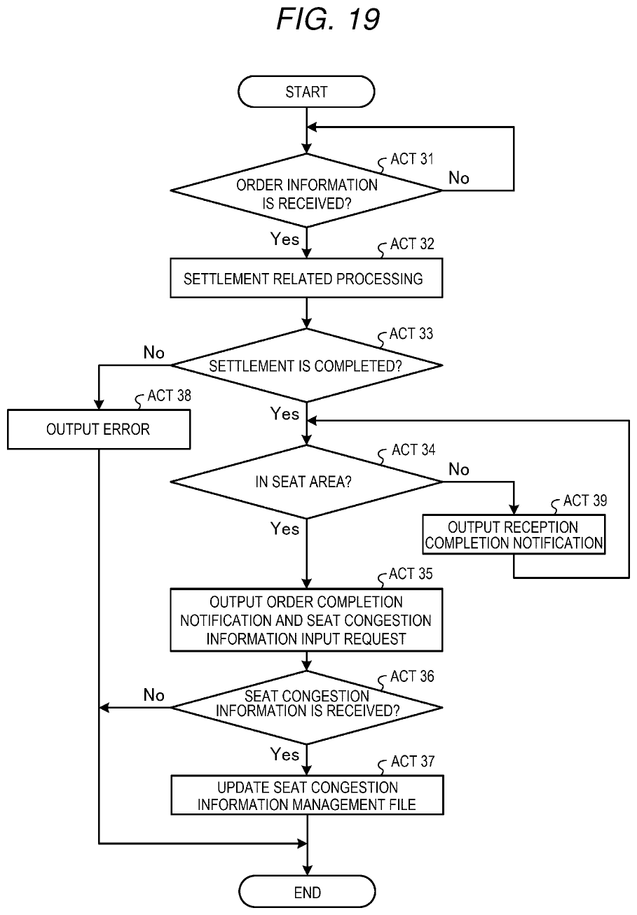

FIG. 19 is a flowchart illustrating the seat congestion information update processing by the control unit 20 of the server device 2.

The control unit 20 determines whether the receiving unit 2001 received order information (Act 31) and, if the receiving unit 2001 did not receive order information (N in Act 31), returns to the processing in Act 31 and stays on standby.

If the receiving unit 2001 receives order information (Y in Act 31), the order-information processing unit 2005 executes settlement related processing (Act 32) and determines whether settlement is completed (Act 33). If the settlement is completed (Y in Act 33), the control unit 20 determines whether the position detecting unit 2003 detected that the portable terminal 4 is located in the food court (Act 34).

If the portable terminal 4 is located in the food court (Y in Act 34), the output unit 2004 outputs an order completion notification and a seat congestion information input request to the portable terminal 4 (Act 35). The control unit 20 then determines whether the receiving unit 2001 receives, from the portable terminal 4, within a predetermined time, the seat congestion information in response to the seat congestion information input request output in Act 35 (Act 36).

If the receiving unit 2001 receives seat congestion information (Y in Act 36), the managing unit 2006 updates the seat congestion information management file 215 based on the received seat congestion information (Act 37). The control unit 20 ends the congestion information update processing.

If the settlement is not successfully completed in the processing in Act 33 (N in Act 33), the output unit 2004 outputs error information indicating that the settlement is not successfully performed to the portable terminal 4 (Act 38). The control unit 20 ends the congestion information update processing.

If the portable terminal 4 is determined not to be located in the food court in the processing in Act 34 (N in Act 34), the output unit 2004 outputs a reception completion notification to the portable terminal 4 (Act 39) without a request for seat congestion information. Thereafter, the control unit 20 returns to the processing in Act 34. After the control unit 20 returns to the processing in Act 34, if the portable terminal 4 is subsequently determined to be located in the food court and the control unit 20 shifts to the processing in Act 35 and the output unit 2004 may output a seat congestion information input request to the portable terminal 4.

If the receiving unit 2001 does not receive seat congestion information in response to the transmitted request even after the predetermined time elapses in the processing in Act 36 (N in Act 36), the control unit 20 determines that the user did not input seat congestion information and ends the congestion information update processing.

According to the congestion information update processing, the server device 2 can collect seat congestion information without installing additional equipment, such as a dedicated sensor or sensors for detecting customers in the seats T in the food court. Moreover, since the seat congestion information to be collected is input by those users located in the food court, it can be expected that reliability of the information is secured.

### Modification

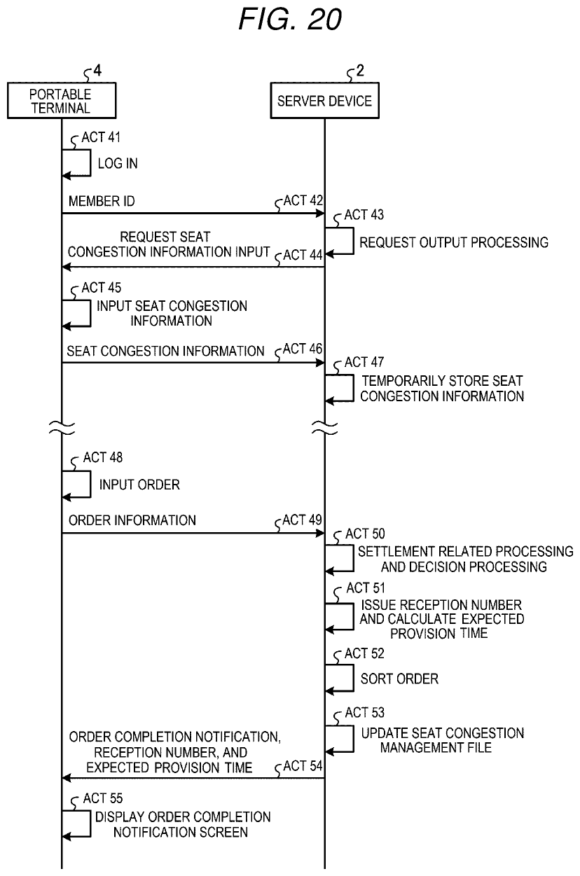

A modification of the congestion information update processing is explained. The modification is different from an example explained above in that the seat congestion information input request is output to the portable terminal 4 before it is decided an order is complete, in other words, seat congestion information can be input via the portable terminal 4 before the user has decided on an order (e.g., either during ordering or before order entry). FIG. 20 is a sequence chart illustrating a flow of an operation at a seat congestion information update time in the present modification.

The portable terminal 4 executes processing for logging in to the website of the food court (Act 41). When the processing for logging in is executed, the portable terminal 4 outputs a member ID of the member carrying the portable terminal 4 to the server device 2 (Act 42).

Upon receiving the member ID, the server device 2 outputs a seat congestion information input request (Act 43) and transmits the seat congestion information input request to the portable terminal 4 (Act 44).

If seat congestion information is input by the user at this time (Act 45), the portable terminal 4 transmits the input seat congestion information to the server device 2 (Act 46). Thus, the portable terminal 4 can provide seat congestion information during the login proves for the website of the food court. The server device 2 stores the received seat congestion information in the RAM 203 (Act 47).

Thereafter, if an input relating to an order is performed on the portable terminal 4 (Act 48), the portable terminal 4 outputs the order information to the server device 2 (Act 49). The order information output from the portable terminal 4 includes the member ID, a commodity ID for identifying an input ordered commodity, and a store ID for identifying the store S that provides the ordered commodity.

The server device 2 executes settlement and other related processing based on the order information acquired from the portable terminal 4 (Act 50). The server device 2 dispenses a reception number for the received order information, calculates an expected provision time of the ordered commodity (Act 51), and executes order sorting processing as necessary (Act 52).

In this example, if settlement relating to the order information is successfully completed, the server device 2 updates the seat congestion information management file 215 based on the seat congestion information that was previously stored in Act 47 (Act 53). Thereafter, the server device 2 outputs information indicating an order completion notification, the reception number, and the expected provision time to the portable terminal 4 (Act 53). The portable terminal 4 displays an order completion notification screen based on the information acquired from the server device 2 (Act 55).

According to the modified operation illustrated in FIG. 20, the user can input the seat congestion information into the portable terminal 4 before an order completion notification is received by the portable terminal 4. Consequently, it can be expected that more seat congestion information will be collected.

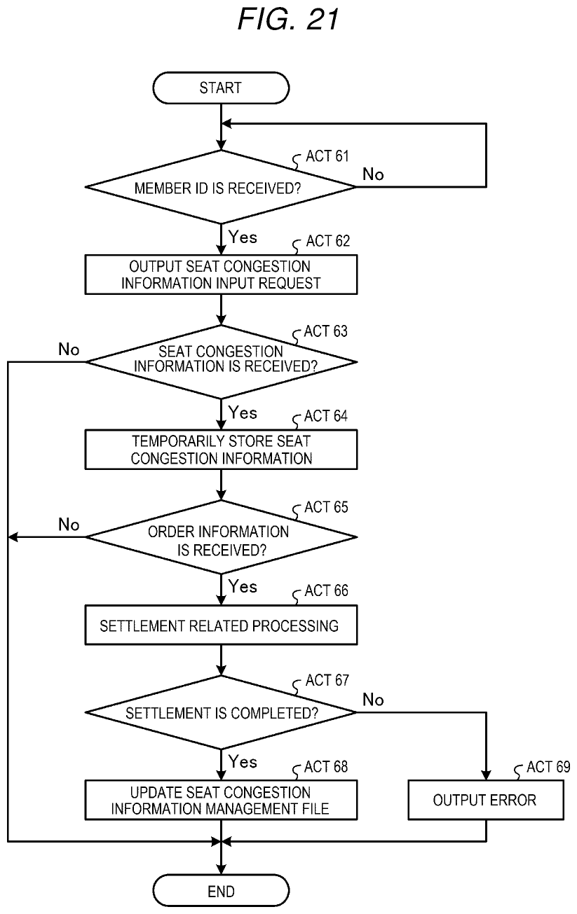

FIG. 21 is a flowchart illustrating seat congestion information update processing by the control unit 20 of the server device 2 in this modification.

The control unit 20 determines whether the receiving unit 2001 received a member ID (Act 61). If the member 2001 did not receive a member ID (N in Act 61), the control unit 20 returns to the processing in Act 61 and stays on standby (waits).

After the receiving unit 2001 receives a member ID (Y in Act 61), the output unit 2004 outputs a seat congestion information input request to the portable terminal 4 (Act 62). Subsequently, the control unit 20 determines whether the receiving unit 2001 received seat congestion information (Act 63). If the receiving unit 2001 receives seat congestion information (Y in Act 63), the control unit 20 temporarily stores the received seat congestion information in the RAM 203 (Act 64).

Subsequently, the control unit 20 determines whether the receiving unit 2001 received order information (Act 65). If the receiving unit 2001 receives order information (Y in Act 65), the order-information processing unit 2005 executes settlement related processing (Act 66) and determines whether settlement has been successfully completed (Act 67). If the settlement is successfully completed (Y in Act 67), the managing unit 2006 updates the seat congestion information management file 215 based on the seat congestion information that was stored in the RAM 203 (Act 68). The control unit 20 ends the congestion information update processing.

If the receiving unit 2001 does not receive seat congestion information even after a predetermined time elapses in the processing in Act 63 (N in Act 63), the control unit 20 determines that seat congestion information is not input by the user and ends the seat congestion information update processing. If the receiving unit 2001 does not receive order information even after a predetermined time elapses in the processing in Act 65 (N in Act 65), the control unit 20 ends the seat congestion information update processing.

If the settlement is not successfully completed in the processing in Act 67 (N in Act 67), the output unit 2004 outputs error information indicating that the settlement is not successfully completed (Act 69). The control unit 20 ends the seat congestion information update processing.

According to the congestion information update processing in this modification, the server device 2 can receive the seat congestion information even before the order completion notification is transmitted. Therefore, it can be expected that more seat congestion information will be collected. Moreover, since the update of the seat congestion information management file 215 is performed based on the seat congestion information input by a user who actually ordered, it can be expected that reliability of tracked seat congestion information is improved.

A server device 2 in an embodiment includes an order-information receiving unit that receives order information from a terminal device operated by a customer. If an order of a commodity was executed, an input request for seat congestion information is sent to the terminal device from the server device 2. If sent congestion information is sent in response to the transmitted request (or otherwise), the server device uses the provided information to track a congestion state of the shared seats (seats T) of a food court or the like based on the congestion information sent by the user terminal.

The server device 2 may request seat congestion information from a user at one or more points in the ordering process, for example, at user login, upon successful order settlement, upon notification an order is ready for pickup, or the like. Inclusion of the user provided seat congestion information in evaluation of a seat congestion state may be contingent on successful order completion (e.g., successful payment processing) to enhance information reliability. In some examples, order entry may be made contingent on provision of seat congestion information by the user.

Since the server device 2 track the congestion state of the shared seats T based on the seat congestion information provide by service users from portable terminals 4, it is possible to collect the seat congestion information without requiring additional equipment (e.g., cameras, sensors, or the like). Since the server device 2 collects the seat congestion information from the portable terminal 4 from which the order of the commodity was performed, it is possible to improve accuracy of the congestion information collected.

The server device 2 can urge the user to input the congestion information when the user checks the order completion information. Accordingly, it is possible to prevent the user from overlooking the input screen for the congestion information and thus to collect more congestion information.

In some examples, the server device 2 can collect seat congestion information from only those users located in near the seats T and can thus improve reliability of the collected seat congestion information.

For example, the server device 2 in an embodiment further includes the position detecting unit 2003 that detects whether a terminal device (the portable terminal 4) that sent order information is located in an area where the seats T are arranged. The output unit 2004 outputs an input request for congestion information only to a terminal device that the position detecting unit 2003 detects in the relevant area.

The control programs used in the server device 2, the store terminal 3, and the portable terminal 4 may be provided by being recorded in a non-transitory computer-readable recording medium such as a CD-ROM. The control programs executed in the server device 2, the store terminal 3, and the portable terminal 4 may be provided by being stored on a computer connected to a network, such as the Internet, and downloaded through the network or otherwise provided through the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server device, comprising:
a storage unit;
a communication interface configured to connect to store servers and customer terminals; and
a control unit configured to:
receive an order from a customer terminal via the communication interface for an item at a store in a plurality of stores at a facility shared by the plurality of stores,
output, via the communication interface, a seat congestion information request to the customer terminal, the seat congestion information request causing the customer terminal to display a request on the customer terminal for an input of congestion information indicating a congestion state of shared seats at the facility,
receive the congestion information from the customer terminal device, and
track the congestion state of the shared seats based on the congestion information.

2. The server device according to claim 1, wherein the seat congestion information request is sent after settlement processing for the order is completed.

3. The server device according to claim 1, wherein the seat congestion information request is sent after an order confirmation is received from the customer terminal in response to an order confirmation request sent, via the communication interface, to the customer terminal.

4. The server device according to claim 1, wherein the seat congestion information request is sent to the customer terminal immediately after a user logon to an ordering service provided by the server device.

5. The server device according to claim 1, wherein the control unit is further configured to obtain a position of the customer terminal at the time the order is received from the customer terminal.

6. The server device according to claim 5, wherein the control unit is further configured to send the seat congestion information request only if the position of the customer terminal is inside an area of the facility including the shared seats.

7. The server device according to claim 1, wherein the control unit is further configured to obtain a position of the customer terminal and send the seat congestion information request when the position of the customer terminal is inside an area of the facility including the shared seats.

8. The server device according to claim 1, wherein, when the order is for a plurality of items from multiple stores in the plurality of stores, the control unit is further configured to send, via the communication interface, order information to store servers of each of the multiple stores.

9. The server device according to claim 1, wherein the control unit comprises a processor executing a software program.

10. A server, comprising:
a processor configured to:
receive an order from a customer terminal via a communication interface for an item at a store,
output, via the communication interface, a seat congestion information request to the customer terminal, the seat congestion information request causing the customer terminal to display a request on the customer terminal for an input of congestion information indicating a congestion state of seats available for customers of the store,
receive the congestion information from the customer terminal device, and
track the congestion state of the seats based on the congestion information.

11. The server according to claim 10, wherein the seat congestion information request is sent after settlement processing for the order is completed.

12. The server according to claim 10, wherein the seat congestion information request is sent after an order confirmation is received from the customer terminal in response to an order confirmation request sent, via the communication interface, to the customer terminal.

13. The server according to claim 10, wherein the seat congestion information request is sent to the customer terminal immediately after a user logon to an ordering service provided by the server device.

14. The server according to claim 10, wherein the processor is further configured to obtain a position of the customer terminal at the time the order is received from the customer terminal.

15. The server according to claim 14, wherein the processor unit is further configured to send the seat congestion information request only if the position of the customer terminal is inside an area including the seats.

16. A non-transitory, computer-readable medium storing program instructions which when executed by a server device cause the server device to perform a method comprising:
receive an order from a customer terminal via a communication interface for an item at a store in a plurality of stores at a facility shared by the plurality of stores;
output, via the communication interface, a seat congestion information request to the customer terminal, the seat congestion information request causing the customer terminal to display a request on the customer terminal for an input of congestion information indicating a congestion state of shared seats at the facility;
receive the congestion information from the customer terminal device; and
track the congestion state of the shared seats based on the congestion information.

17. The non-transitory, computer-readable medium according to claim 16, wherein the seat congestion information request is sent after settlement processing for the order is completed.

18. The non-transitory, computer-readable medium according to claim 16, wherein the seat congestion information request is sent after an order confirmation is received from the customer terminal in response to an order confirmation request sent, via the communication interface, to the customer terminal.

19. The non-transitory, computer-readable medium according to claim 16, wherein the seat congestion information request is sent to the customer terminal immediately after a user logon to an ordering service provided by the server device.

20. The non-transitory, computer-readable medium according to claim 16, the method further comprising:
obtain a position of the customer terminal at the time the order is received from the customer terminal.
